(19) United States
(12) Patent Application Publication
(10) Pub. No.: US 2014/0297736 A1
(43) Pub. Date: Oct. 2, 2014

(54) DATA INTERCHANGE SYSTEM

(71) Applicant: LXM Pty Ltd, Crows Nest (AU)

(72) Inventor: Bernard Sircelj, Edmondson Park (AU)

(21) Appl. No.: 14/356,520

(22) PCT Filed: Oct. 29, 2012
(86) PCT No.: PCT/AU2012/001325

§ 371 Date: May 6, 2014

(30) Foreign Application Priority Data
Oct. 28, 2011 (AU) 2011904505

(51) Int. Cl. H04L 29/08; H04L 29/12

(52) U.S. Cl. CPC H04L 67/10; H04L 61/604; H04L 67/1095
USPC 709/203

(57) ABSTRACT

A data interchange system for a remote presentation service that applies especially to client/server applications for computer networked systems. The performance of a networked system that requires transferring data between a server and a client application can be improved by utilising very thin clients, such as with apps on smart phones for instance, where the business rules needed to operate the application are situated on the server as much as possible, instead of within the client application. Additionally, the quantity of data that is required to be displayed on or operate a client application should be kept to a minimum, which may be done by only transferring the least amount of data required, and also be taking advantage of default values for fields and not transferring any data if it matches the default. This approach has the further advantage that new client applications can be more quickly developed and deployed for a wide variety of alternate client platforms.

### TECHNICAL FIELD

The present invention relates to a data interchange system for a remote presentation service that applies especially to client/server applications for computer networked systems. The performance of a networked system that requires transferring data between a server and a client application can be improved by utilising very thin clients, such as with apps on smart phones for instance, where the business rules needed to operate the application are situated on the server as much as possible, instead of within the client application. Additionally, the quantity of data that is required to be displayed on or operate a client application should be kept to a minimum. This can be done by only transferring the least amount of data required, and also be taking advantage of default values for fields and not transferring any data if it matches the default. This approach has the further advantage that new client applications can be more quickly developed and deployed for a wide variety of alternate client platforms.

### BACKGROUND ART

The financial services industry, like other sectors, has a long history of using a Client/Server approach for software development. There is now something of a shift going on in relation to the platform and technologies on which to deploy such software solutions. One major shift has been to the deployment of cloud computing solutions.

There are some advantages for migrating a Client/Server software application over to a thin client hosted solution. This approach allows for a wide variety of client devices to be used, especially small and portable devices, such as mobile phones, smart phones, tablets, or net books, in addition to PCs. The client application can often use a standard internet browser as its interface, or a small applet on a smart phone for example, in place of dedicated application or program that is often large and resource intensive. Also, the level of support required is generally less in such thin client and hosted solutions. With a hosted solution there will be little support required for the client installation; support is mostly only needed for the server. This is even more pronounced if the hosted solution is a multi-tenanted solution, in which case support is only needed for a single server instance regardless of the potentially large number of tenants, whereas traditionally there would be a need to support one server for each tenant. But there are disadvantages as well. When the application is split between the server and the client then large amounts of data must usually be transferred over the network between the two, and as bandwidth is often limited especially with wirelessly connected devices, the performance of the application will suffer as a result.

There are a variety of platforms that can be used to create thin client/server applications. For example, some platforms that can be utilised for the client application include: HTML, HTML5, Microsoft Silverlight, Adobe Flash, Java, native operating system applications such as Microsoft Windows application, Microsoft Mobile application, Apple OSx application, Apple iOS application, Google Android application, etc. Some platforms for web servers include: Microsoft .net, Java, C, C++, Cobol, PHP, etc. Some Remote Procedure Call (RPC) techniques include: SOAP, REST, DCOM, CORBA, etc. Some serialisation methods include: XML, JSON, CSV, Binary, etc. Some duplex communication approaches include: Web Sockets, long-Polling, net TCP Binding, Http Duplex Binding, etc. Some of the permanent storage (eg, database) server platforms include: Microsoft SQLServer, MySQL, Oracle, IBM DB2, Microsoft Azure table storage, and flat files, for instance.

There is currently renewed interest in this, and a number of new technologies are being touted as a platform for the development of better thin client user interface platforms. Various user interface platforms are available, including Microsoft Silverlight, HTML, Java and the various proprietary solutions required for the iOS platform (ie the Apple™ “iPad” and “iPhone”) as well as for other smart phone or tablet platforms like “Android”. The number and variety of the client user interface platforms that are available, as well as the idiosyncrasies inherent in each of them, all present problems for the development of a software solution. Using traditional techniques to communicate between the client application and the server has disadvantages because of the long time required for a software developer to bring a solution to market on each of the various user interface platform technologies, which keep on evolving and expanding.

Typically, web services are invariably designed to return a rich data set, containing a large and detailed set of data, based on the premise that the client application consuming the service either contains the business logic to handle this data or that the client application might use it later. An example of such a web service can be, for example, a Customer Relationship Management (CRM) system or web service in which a person's contact information can be created, read, updated or deleted. Client applications are then developed to consume these services, and present the data in a number of different forms and navigation. This scenario is common to many other types of applications, and is not limited to CRM products.

In many instances these services return data containing, for example such items of information as a person's name, current and previous contact details (address, phone, fax, mobile, email), date of birth, etc. When the client application is developed, and consumes this service all of this data must be transferred from the server even if the client application only wishes to display the person's date of birth, for instance.

Software houses want to develop solutions that require the smallest amount of their effort in order to migrate the client application across to all the various user interface platforms that are available and which need to be catered for. This goal is actually quite difficult to achieve. Another consideration may be that some mainstream providers (Microsoft, Apple, Google, etc) may prefer to maintain or encourage the status quo, because otherwise developers could more easily change user interface platforms. The investment in time and effort to develop for a specific platform means that developers may be more likely to continue to enhance applications on the original platform rather than to deliver on a whole multitude of other and often newer platforms.

Therefore, there would be advantages in providing a solution that facilitates fast migration between the various user interface platforms in a thin client environment, or at least provides a useful alternative to current approaches.

### DISCLOSURE OF THE INVENTION

A first aspect of the invention provides a client-server network of electronic devices that contains: at least one server device having at least one database, and at least one server application that is adapted to process data in said database according to some business rules, and at least one client device having at least one client application that is adapted to receive data input from a user and transmit this to the server application over the network and to display to the user data input by the user or received from the server application over the network, and the client application being adapted to process data according to some business rules, whereby the client application exchanges data with the server application over the network at least in part asynchronously, and the client application and the server application are synchronised with each other during the asynchronous data exchange.

As used herein, the term “database” is to be interpreted as any form of long-term or permanent data storage, which includes relational databases, other databases, fixed files, and other means of data collocation in an electronic storage device.

### BRIEF DESCRIPTION OF THE DRAWINGS

Preferred embodiments of the invention will now be described, by way of example only, with reference to the accompanying drawings in which:

FIG. 1 is a block diagram illustrating the application architecture for the invention,

FIG. 2 is a flow diagram illustrating the application process flow,

FIG. 3 is a data sequence diagram illustrating the traditional approach,

FIG. 4 is a data sequence diagram illustrating the invention,

FIG. 5 shows an example of a data model, which is used in an Example below,

FIG. 6 shows an example of the Graphical User Interface (GUI) form that is associated with the data model in FIG. 5,

FIG. 7 shows one example of a general client application request and server response data structure for the invention,

FIG. 8 is an example of a response written in XML,

FIG. 9 is an example of a response written in JSON, and

FIG. 10 is an example showing comparative test results for the performance of the invention over the prior approach.

### MODES FOR CARRYING OUT THE INVENTION

The invention provides a solution in order to permit faster migration between the various user interface platforms by making the client-side business processes be as thin as possible. This involves making the corresponding server processes as smart as possible while removing most of the business logic from out of the client user interface platform.

This may be done by providing a client-server network of electronic devices that contains at least one server device having at least one database, and at least one server application that is adapted to process data in the database according to some business rules, and at least one client device having at least one client application that is adapted to receive data input from a user and transmit this to the server application over the network and to display to the user data input by the user or received from the server application over the network, and the client application being adapted to process data according to some business rules, whereby the client application exchanges data with the server application over the network at least in part asynchronously. This exchange of data can be initialised by either the client application or the server application, resulting in the client application and the server application being synchronised with each other during the asynchronous data exchange.

This new approach utilises a chatty data transfer process via asynchronous communication. This process is called the Remote Presentation Service (“RPS”) in this document. The RPS lets the user interface transfer back to the server only the specific data fields that have been changed. The server would then run the appropriate business logic associated with the change and send only the properties of user controls and components contained within the Graphical User Interface (GUI) that had been modified back to the client.

This process may only send the data displayed on the client user interface platform on the initial load of the page, as well as only sending the data element that was changed, from the client to the server, to then be displayed on the client after a response from the server.

It has now been found that this can improve the speed of communication between the client and the server by a significant factor. This is primarily achieved through the reduced amount of data required to be transferred, but it may be even further improved through the initial use of default values in various fields that utilise such values. If the data to be displayed actually matches the default, which is a relatively common situation, then this data does not need to be transferred.

There can be numerous other benefits in using the RPS approach. For example, the server is able to store each change that the user performs within the session, in that it is “stateful”. A process that is stateful keeps track of each transaction, in contrast to a “stateless” one that does not record the history of the transactions occurring. Therefore, under the RPS model, if the client loses its connection to the server, once they are reconnected they are able to re-establish their session with loss of little, if any, data. This is of particular benefit for applications running on mobile phones, for example, where the network connection is easily disrupted.

Another benefit is that the size of the client install is minimised, and in some situations there may be no install requirements needed at all. Because the client application requires little to no business logic, the size of the client application is small since the number of lines of coding to develop the client application is small.

In the past, a typical approach wasted bandwidth and performance because the entire data result was transferred regardless of whether it was used or not. It is now possible to minimise this problem by only returning the explicit data the client application is requesting. For the above example describing a CRM system under the RPS model, then the client application would request the date of birth and the server would only return the date of birth, instead of the entire data set needed to populate a web page or form.

The examples described herein can be developed using Microsoft Silverlight, and Microsoft Windows Communication Foundation (“WCF”) or alternatively, Microsoft ASP.net MVC WebAPI, SignalR, as well as Microsoft SQL Server as the primary platforms. However, other platforms may be used instead to create such an application, as mentioned above.

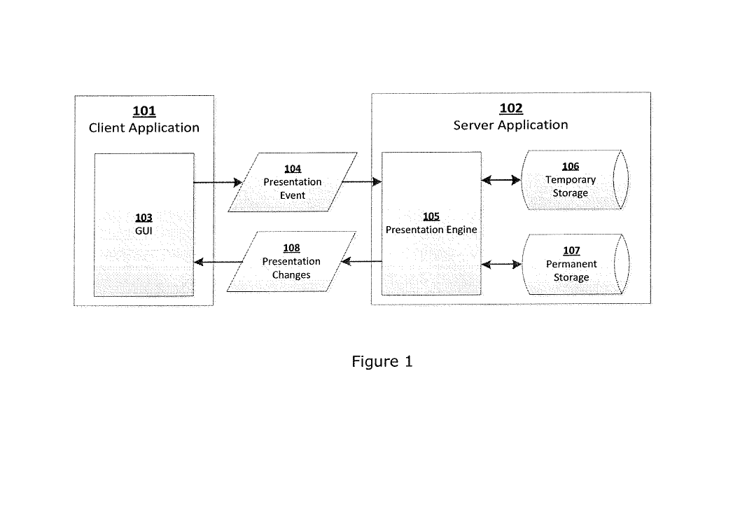

As shown in FIG. 1 of the drawings it is a goal of the Remote Presentation Service (RPS) according to the present invention, to remove some, or preferably the majority of the business rules defined within the client 101 and move them onto the server 102, which is both persistent and stateful. Most, and preferably all, or as many as possible, of the business rules are relocated to the server. In order to achieve this, both the client 101 and the server 102 need to be synchronised. This may be achieved by sending asynchronous 104 messages from the client 101 and responding with messages 108 back from the server 102 for each Graphical User Interface (GUI) event 103. Alternatively, this may be achieved by broadcasting 108 messages from the server 105 to the client or clients 101 whenever a change has been made by the server 102.

Preferably the majority of the business rules are held and processed on the server, and more preferably at least about 80% are on the server, or better still at least around 90% or 95% or the rules are located there. In an ideal situation 95% to 100% of the rules are held and processed on the server, and only 0% to 5% of the rules are on the thin client. The extent of rules to go on the server is generally determined on a case-by-case basis. In some instances it will be possible to move 100% of the business rules over to the server, but in others it will only be possible to move the majority over, and there will still be a portion on the client. In an ideal situation, 100% of the complex business rules will be on the server, while some simplistic business rules that may not affect the data can be defined on the client. The preferred objective is to get the majority, if not all, of the business rules over onto the server. Another consideration is that the more business rules that remain on the client, then the more that will later have to be converted each time there is a need to develop a new client application.

As used herein, an event is the immediate result of an action such as changing a textbox value, clicking a button, etc. Generally only the event that arises from the action initiated by the user is transmitted back to the server application, for processing.

Also, a message is a communication package that contains a set of data that is passed between the client or server applications. The recipient of the message reads the message and understands what to do with the data contained within the message.

For example, a message 104 from the client may be an item of text that has changed, like the first line of an address, or the clicking of a button to indicate that the text revision is complete. Similarly, a message 108 from the server to the client can be the amended line of text showing the first line of the address to repaint the display of the entire address on a page or form. RPS works by the client application sending a message to the server for each event. An event can be a change of a value within a text box or a click of a button, for example. The content of the message contains what control caused the event and the updated value. In the case of changing an address textbox, the message would contain “Address_Textbox” as the cause and the value would be the new address that was entered. In the case of clicking the save button, the message would contain “Save_Button” as the cause and the value would be ‘click’.

At other times it is possible that the server has itself made some changes. This can occur when another process has updated the user's temporary storage 106, such as with automated processes, external systems or concurrent users. When this occurs the server broadcasts a message 108 to the affected client/s 101, notifying them of the change.

Another goal of the Remote Presentation Service according to the invention is to keep the messages 104, 108 that travel between the client and server as small as possible. This is achieved by providing only the data that is absolutely required. If the data does not have a direct impact on the Graphical User Interface (GUI) 103 then it ideally should not form part of the message 108.

It is possible to make the messages 104, 108 even smaller if the messages are compressed prior to sending them. The recipient is then required to un-compress the message before processing them. If compression is used, then any generally available compression protocol may be utilised. Some examples of this are gzip, deflate, exi, sdch, peerdist, etc.

All user controls and components contained within the Graphical User Interface (GUI) 103 have default values for each property (Visible, Enabled, Value etc. . . . ). The presentation engine 105 should be conscious of these default values when populating the message 108. There can be performance advantages also in relying on default values, and not transmitting data over the network for fields which match the default value. Using default values in this manner is generally only useful for the initial creation of the form. If a change has happened that changes the default value and then there is subsequently a need to change it back to the default value then the system will need to send the value across the wire irrespectively.

The presentation engine 105 is business logic on the server that interprets each of the messages received from the client and determines what to do with them. In most cases it updates the corresponding value stored in the temporary storage 106, but also applies any necessary business logic that is required, such as saving the data stored in temporary storage 106 into permanent storage 107 when it receives a message that contains a “Save_Button” cause and a value of click. It then scans for changes made to the data stored in temporary storage 106 and creates a message to send back to the client to reflect those changes.

An advantage of the Remote Presentation Service is the ability for developers to quickly develop and deploy new client applications for different platforms and technologies. This is made possible because by removing the majority if not all business rules defined within the client 101 and moving them onto the server 102, means that the client application 101 is very dumb, and is simple and easily reproducible as it does not contain any complicated programming logic.

An architectural overview of the remote presentation service is shown in FIG. 1. A typical client application 101 is developed to use the remote presentation service. The client application 101 is not limited to any one technology and could easy be developed for any platform or developed using any language or technology. Some examples of suitable languages include: .Net, Java, JavaScript, C, C++, Perl, PHP, Python, Ruby, and Delphi. Some examples of suitable technologies include: console applications, mobile applications, web applications, plugin applications, applets, and native OS applications.

Just like a typical client application, the application 101 generally contains a Graphical User Interface (GUI) 103. A Graphical User Interface (GUI) contains many user controls and components allowing the user to interact with the application 101. When a user of the application 101 interacts with the application an asynchronous message 104 is fired off to a presentation engine 105, which is hosted by the server application 102. The application 101 then listens for a message 108 in response. Upon receiving a message response 108, the Graphical User Interface (GUI) 103 is updated to reflect the changes received within the message 108.

The original message 104 contains details of the User Interface (UI) event that occurred. For example if a user clicked on a button, the message 104 would contain the identification of the button, and that it was pressed. Alternatively if the user changed a text-box value, for example from “22 Smith Street” to “23 Smith Street”, then the message would contain the identification of the field such as “Address_Line_{—}1” for example, that it was changed and the new value that was entered, namely “23 Smith Street”.

The server application 102 is able to host the remote presentation service. The server application 102 is not limited to any one specific technology and could easily be developed for any platform or developed using any language or technology. Some examples of suitable languages include: .Net, Java, JavaScript, C, C++, Perl, PHP, Python, Ruby, and Delphi. Some examples of suitable server platforms include: Microsoft Server, Microsoft Azure, Amazon Cloud Services, Salesforce.com, Google Cloud Services, Unix, IBM Websphere, Oracle Web Logic, SAP, JBoss, and ColdFusion.

The presentation engine 105 is where everything comes together. It is an abstraction of what would normally happen within the client application. This engine 105 listens for messages 104 submitted by client application 101 and determines what to do with them. The presentation engine 105 contains business logic that defines what should be done with each message 104, and if required responds to the client with a return message 108.

At times, the presentation engine may be notified of changes that have not originated from the client application 101. This occurs when another process has updated the user's temporary storage 106, such as with automated processes, external systems or actions by concurrent users. When this occurs the presentation engine 105 contains business logic that defines what should be done, and if required the server then broadcasts a message 108 to the affected client application/s 101, notifying them of the change. The server application 102 does not expect a response from the client application 101 when such a message is sent.

The temporary storage 106 contains a stateful data set which is constantly synchronised by the presentation engine 105 to accurately represent the current data state presented on the client application 101. The temporary storage 106 is basically the memory the server will utilise to store the client's data. This could be as simple as the web server's session or could be a scalable and high available cache storage solution, etc. The temporary storage 106 may also provide an additional feature where if the connection between the client 101 and server 102 is severed, the user can reconnect and resume their previous session with a loss of little, if any, data or changes.

A permanent storage 107 contains a copy of the data onto a permanent storage device such as a database. The use of this terminology of “permanent storage” and “database” should be interpreted broadly, as any commonly recognised data storage for long term data storage. It may not necessarily be a database per se, but includes flat files or other methods of permanently or fixedly storing data. The permanent nature is to be interpreted in a software sense, as keeping data in a fixed form for long or short time periods. Such databases may be a relational type of database such a SQL database, or any other type of database or data collocation, which is maintained on the server device. This data is either used to initialise the temporary storage 106 or to commit changes from the temporary storage 106.

The return message 108 is simular to the originating message 104, but in reverse. The 108 message contains details of the User Interface (UI) updates that are required. For example, if the presentation engine 105 has business logic to calculate the sum of two fields in response to a message 104, and that field is displayed on the GUI 103, then the message would contain the identification of the text-box, targeting the “value” property as well as the new value that was calculated. Alternatively if presentation engine 105 had business logic to hide a control in response to a presentation event message 104, and that control is displayed on the GUI 103, then this message would contain the identification of the control, targeting the “visibility” property and setting it as “false”, for example.

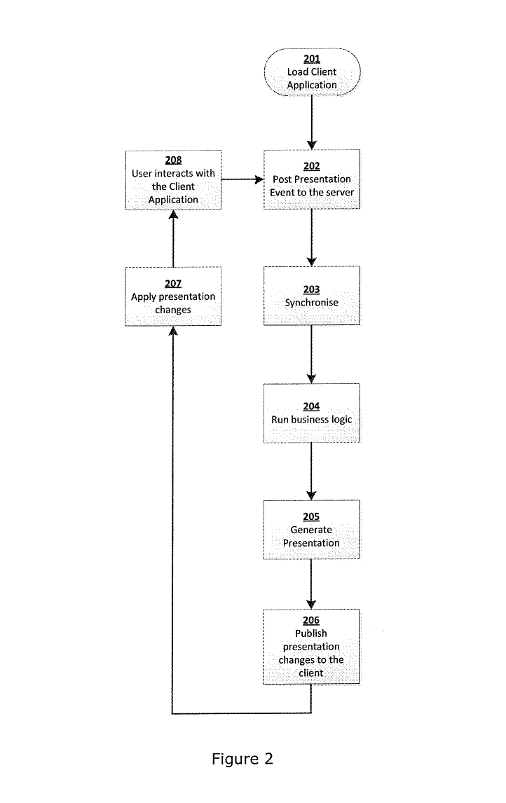

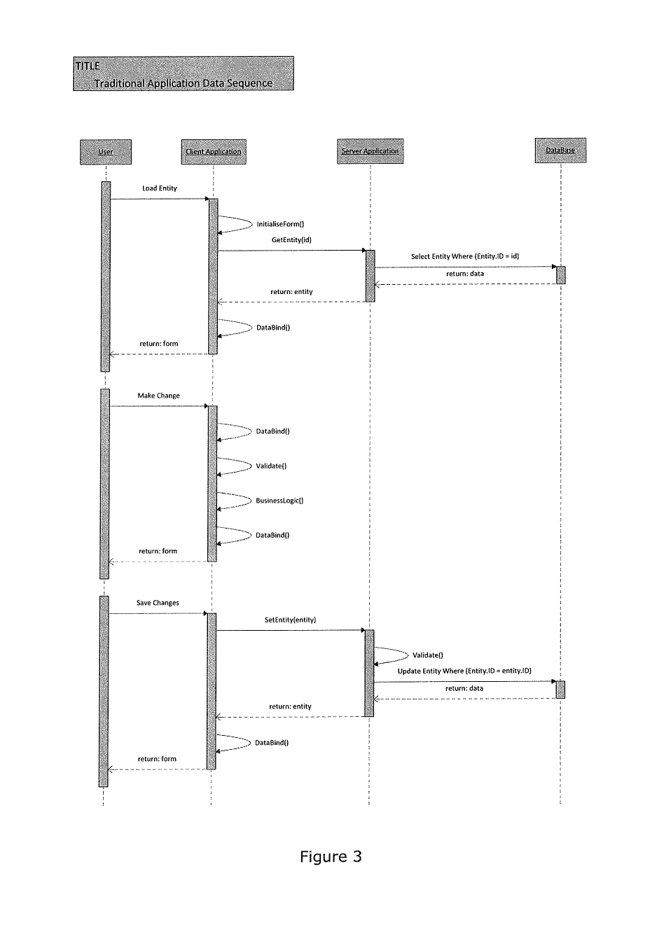

FIG. 2, shows a process flowchart of the interaction between the Client Application 101 and the Server Application 102.

In the first step 201, a user loads an application that is developed to use the remote presentation service. This causes a load presentation event message to be fired 202 to the server. Upon receiving this presentation event message the temporary storage 106 is synchronised 203 by updating the corresponding field value with the one defined within the presentation event message. If there is no value defined within the presentation event message no action is performed by the synchronisation step 203.

Based on the presentation event message received, a number of business rules are then executed 204 in response to the presentation event message. Should the business rules need to update values, the resulting changes are applied to the temporary storage 106. In the case of receiving a “load presentation event” type message, the business rules would initialise the temporary storage 106 with values stored on the permanent storage 107. Once all business rules are run the temporary storage from before the business logic was applied is compared with the temporary storage after the business logic was run. This will generate a collection of presentation changes 205 which forms a presentation change message to be published 206.

Upon receiving a presentation change message the client application then applies those changes 207. Typically this would be done using data binding, but depending on the technology of the client application this might not be possible, and manual updates may then be required. Some programming languages lack a binding feature. Binding is a programming feature where an object property is mapped with a control property. Whenever one property changes the other changes also. Binding makes RPS straight forward to implement on the client. If the client programming language being used does not support binding then additional programming logic may need to be coded to change the control property value with the object property value and vice versa. Finally, the client application's Graphical User Interface (GUI) is updated to display the presentation changes to the user.

A user would then continue to interact with the client application 208 by clicking buttons, typing into text boxes, selecting items contained within dropdown boxes and so on, which would fire off new asynchronous presentation event messages 202. This process is repeated until the user quits the client application.

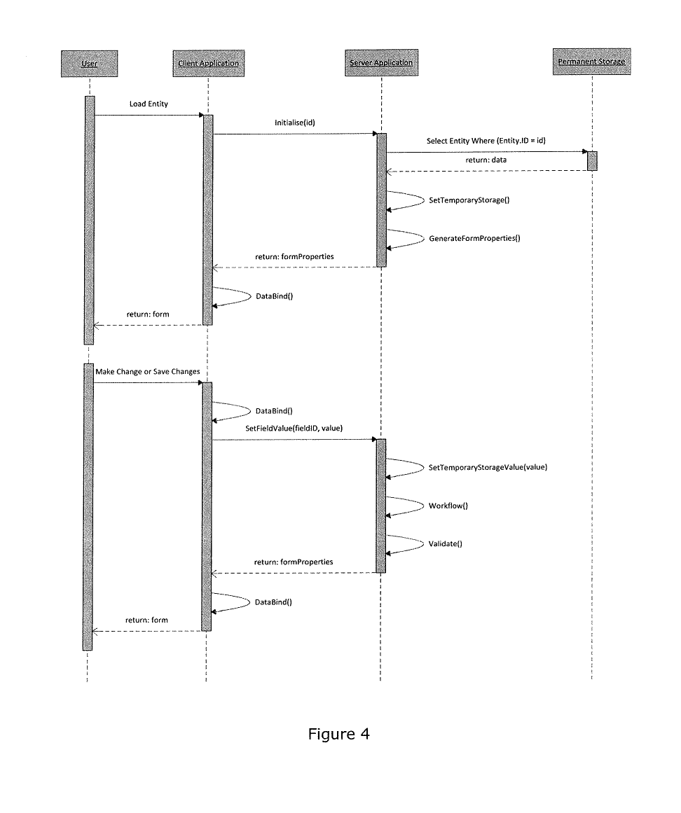

As shown in FIGS. 3 and 4, showing a typical data sequence, it is apparent that the interaction between the Client Application and the Server Application has fewer steps in the approach adopted in the present invention (FIG. 4) than for the conventional approach (FIG. 3).

### EXAMPLES

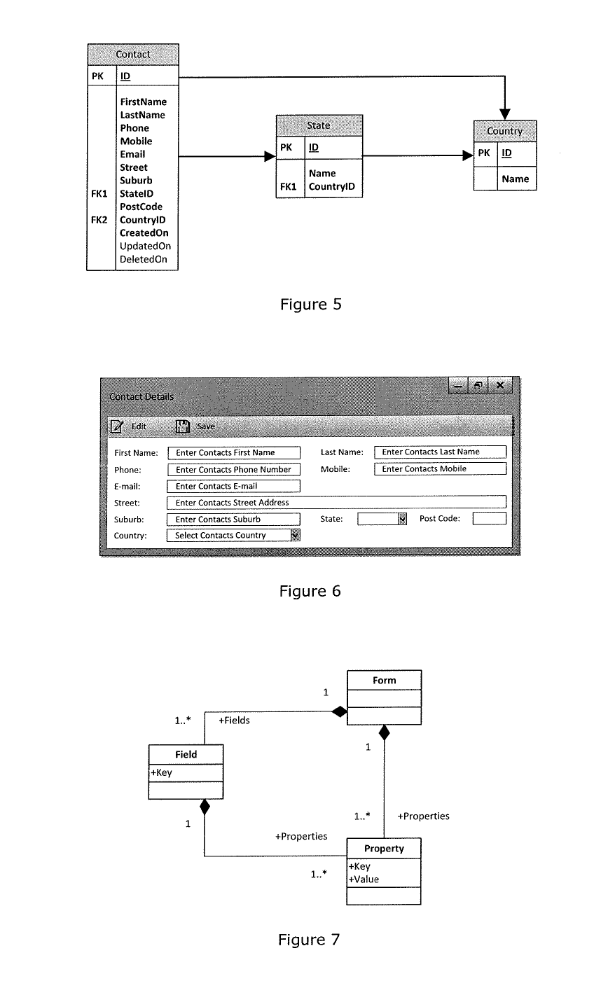

For example, a software company has developed a client application which captures CRM type contact information. In this scenario a user has loaded the client application on a device, such as on a computer connected to the internet, or on a smart phone connected to the server over the communications network. (It should be noted that with HTML pages, in order to benefit from the RPS model, then JQuery, or JavaScript, or the like, may need to be written into the HTML page to communicate with the server, instead of using the standard HTTP post/response techniques.) The user selects an existing contact person to read from the database or permanent storage, with the intent to update the contact information for this person as the person has moved overseas. The data model used is illustrated in FIG. 5 and a typical contact details Graphical User Interface (GUI) form is shown in FIG. 6.

### Example 1

### Conventional Approach

Prior to the present invention, all service calls made to the server from the client application would either be synchronous, asynchronous or a mixture of both depending on the technology used to develop the client application.
Form Load

The application loads the contact details Graphical User Interface (GUI) form, like the one shown in FIG. 6, and gets the data of the selected contact by making a request to the server. The server responds to this request by selecting all the values of the contact data model from the database for the selected contact and returns this data to the client application.

The client application then stores the contact data it received from the server within the client's local memory. Then each field displayed on the contact details form is populated with the corresponding contact data value stored in memory. It is important to note that the server has to return all values defined in the contact data model to the client application regardless if the value is used or not. In this example, in the “Contact” table in the CRM database, the ID, CreatedOn, UpdatedOn and DeletedOn rows of are returned from the server, but the client application never uses them.

The client application needs to populate the contents of the “Country” dropdown list. To do this it needs to get a list of countries by making a request to the server. The server responds to this request by selecting all the records and values of the Country table of the data model from the database or fixed data storage and returns a collection of countries to the client application. The client application then adds a new dropdown item for each country stored within the collection.

The client application also needs to populate the contents of the state dropdown list. To do this it needs to get a list of states by making a request to the server and passes the currently selected country value. The server responds to this request by selecting all the records and values of the “State” table of the data model from the database where the state is related to the country and returns a collection of states appropriate for the selected country to the client application. The client application then adds a new dropdown item for each state stored within the collection.

An alternative approach to populating the states is not to pass the currently selected country when sending the request to the server. This results in all states in all countries being returned. The client application would then filter this list and only add a new dropdown item for each state where the state is related to the selected county. This approach is useful if the users of the application would regularly change countries, to save round trips to the server, but as a result much more data is transferred initially from the server, most of which may never be used.

The contact details Graphical User Interface (GUI) form is initially loaded in read only mode, so the client application has to disable each field displayed.
Click Edit

The user of the client application then clicks on the “Edit” button. The client application reacts to this event and enables each field displayed on the form.
Change Address

The user of the client application then replaces the street and suburb values.

The user then chooses a different country. The client application reacts to this event and clears the items stored in the state dropdown box and then needs to get a list of states by making a request to the server and passes the newly selected country. The server responds to this request by selecting all the records and values of the State data model from the database where the state is related to the county and returns a collection of states to the client application. The client application then adds a new dropdown item for each state stored within the collection.

The user of the client application then chooses a different state and replaces the post code value. Upon changing the post code, the client application reacts to this event and makes a request to the server passing suburb, state post code and country in order to validate that the post code being entered is valid. The server responds by validating the post code and returns the validation result to the client application. If the post code is invalid an error message is returned to the client application and displayed to the user.
Click Save

The user of the client application then clicks on the save button. The client application reacts to this event and updates each contact data value stored in the client's local memory with the corresponding field on the contact details form.

The client application then makes a request to the server passing all contact data values stored in the client's local memory. The server responds to this request by firstly validating all the values. If there are any invalid data items an error message is returned to the client application and displayed to the user, otherwise the database is updated with the values provided by the client application. If the database update was successful the server returns a successful response to the client, where the client application reacts by closing the contact details form. Note that the client application has to return all values defined in the contact data model to the server regardless if the value has been changed or not. In this example, Contact table row values for columns for ID, FirstName, LastName, Phone, Mobile, Email, CreatedOn and DeletedOn are sent to the server, but the values have not changed.

### Example 2

### Remote Presentation Service Approach

In the Remote Presentation Service approach of the invention the service calls made to the server from the client application are made asynchronously, and preferably only pass the values that are directly required.

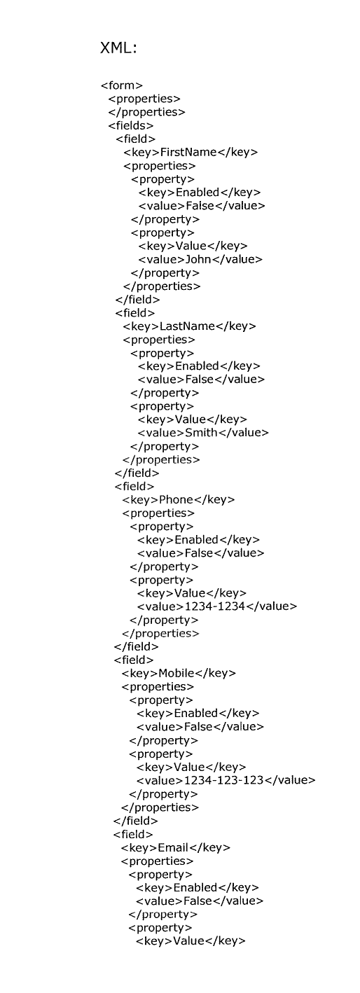

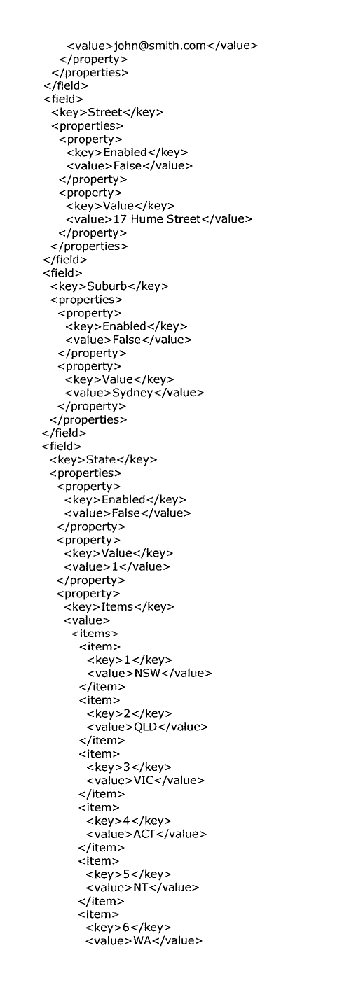

A sample of a client application request and the server response data structure required to implement the remote presentation service is shown in FIG. 7. The approach taken is that for each form there are a number of fields displayed on the Graphical User Interface (GUI) form so a Field class is required for each field. Each such field contains a number of properties such as Value, Enabled, Visible etc, and therefore a Property class is required for each field property. Likewise a form itself may also have some properties. The present example is describing only a simple situation, but more complex examples may also be developed in accordance with the principles and concepts described herein and applied to many different implementations.
Form Load

The application loads the contact details Graphical User Interface (GUI) form, like that shown in FIG. 6, and gets the details of the selected contact by making a request to the server. The server responds to this request by selecting all the values of the Contact table of the data model as in FIG. 5, from the database for the selected contact person and then stores the contact data within the server's memory. This may be in a session or in a cache object, the main objective is that it is stored on the server and not on the client.

The server then starts to build the response. Firstly it creates a Form, and then for each field that will be displayed on the client application creates a field, and for each field it creates a corresponding Value property and sets the value.

Since the contact details Graphical User Interface (GUI) form initially loaded in a read only mode, each field requires a property of “Enabled” being set to “False”.

Since “State” and “Country” are dropdown boxes there is also a need to set a property of “Items” which contains the available list of items.

The server then returns response to the client application.

For this example the response in XML format could look like what is shown in Example 3, below.

Then each property of each field displayed on the contact details form is set with the corresponding form/field property value contained in the data received from the server.
Click Edit

The user of the client application then clicks on the edit button. The client application reacts to this click event and makes a request to the server and passes the field key of the “Edit” button, and a value of “click”. The server responds to this request by building a remote presentation service response and sets each field with only an “Enabled” property to “true”. No other properties are required within the remote presentation service response as they have not changed.

The client application receives the response from the server and then each of the properties of each field displayed on the contact details form is set with the corresponding form/field property value contained in the data received from the server.
Change Address

The user of the client application then replaces the street value. The client application reacts to this change event and makes a request to the server and passes the field key of the street textbox and a “value” property of the new street value. The server responds to this request by updating the contact data stored within the server's memory with the new street value. The server responds with a blank response.

The user of the client application then replaces the suburb value. The client application reacts to this change event and makes a request to the server and passes the field key of the suburb textbox and a “value” property of the new suburb value. The server responds to this request by updating the contact data stored within the server's memory with the new suburb value. The server responds with a blank response.

The user of the client application then chooses a different country value. The Client application reacts to this change event and makes a request to the server and passes the field key of the country dropdown box and a “value” property of the new country value. The server responds to this request by firstly updating the contact data stored within the server's memory with the new country value. Then by building a remote presentation service response and sets a “State” field's “Items” property which contains the available list of states for the new country value and returns this response to the client application.

The client application receives the response from the server sets the state items with the “State” field's “Items” contained in the data received from the server.

The user of the client application then chooses a different state value. The client application reacts to this change event and makes a request to the server and passes the field key of the “State” dropdown box and a “value” property of the new state value. The server responds to this request by updating the contact data stored within the server's memory with the new state value. The server responds with a blank response.

The user of the client application then replaces the postcode value. The client application reacts to this change event and makes a request to the server and passes the field key of the “postcode” textbox box and a value property of the new postcode value. The server responds to this request by firstly updating the contact data stored within the server's memory with the new postcode value. Then it causes a validation to occur to validate the postcode. If the postcode is invalid the server builds a remote presentation service response and sets a postcode field “error” property with the error message and returns this response to the client application, otherwise the server responds with a blank response.
Click Save

The user of the client application then clicks on the “Save” button. The client application reacts to this click event and makes a request to the server and passes the field key of the “Save” button, and a value of “Click”. The server responds to this request by firstly validating the contact data stored within the server's memory. If there are any invalid data items the server builds a remote presentation service response and sets the form “Error” property with the error message and returns this response to the client application, otherwise the database is updated with the contact data stored within the server's memory to the database.

If the database update was successful the server builds a remote presentation service response and sets the form “Visible” property to false and returns this response to the client application.

The client application receives the response from the server sets the form visibility property to false causing the window to disappear.

It should also be noted that in the sample response for Example 3 below, there are no entries for the two buttons (“Edit” and “Save”). This is because by default, buttons have the enabled property set to “true”, so there is no need to pass this data; the default values for these buttons are instead relied upon.

This example can be implemented using Microsoft “Silverlight” Version 4 or 5 and written using C# for the client application, and Microsoft “Windows Communications Services” or Microsoft ASP.net MVC WebAPI and SignalR, and written using C# for the server application and Microsoft SQLServer (eg, 2008) for the database.

### Example 3

### Response

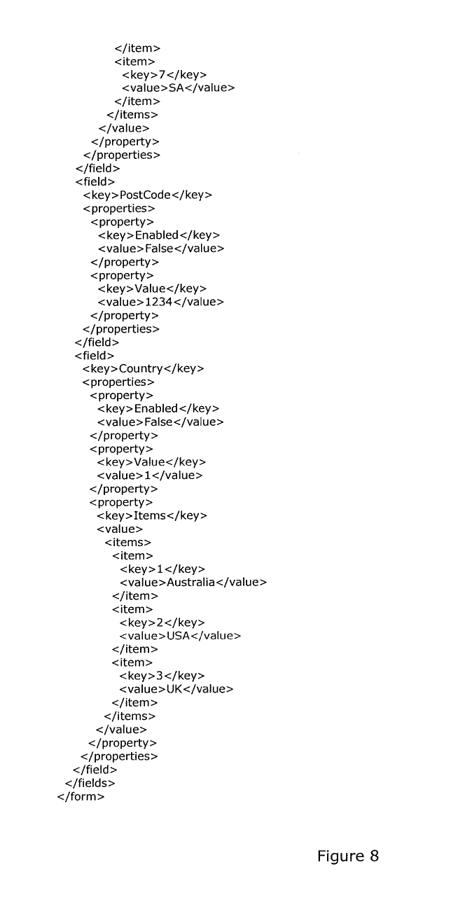

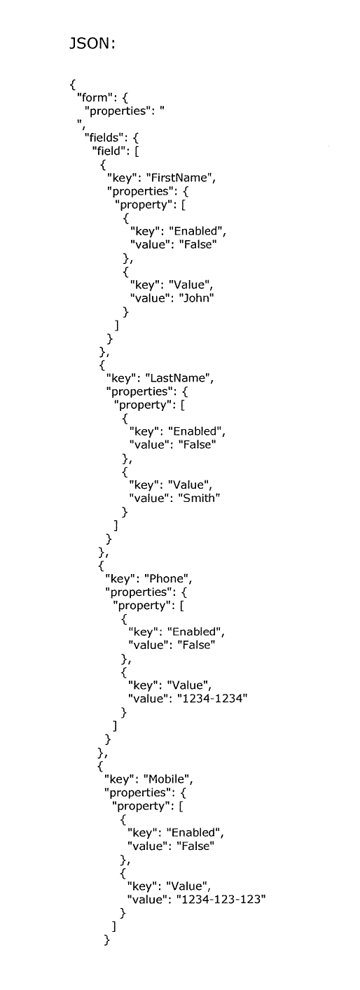

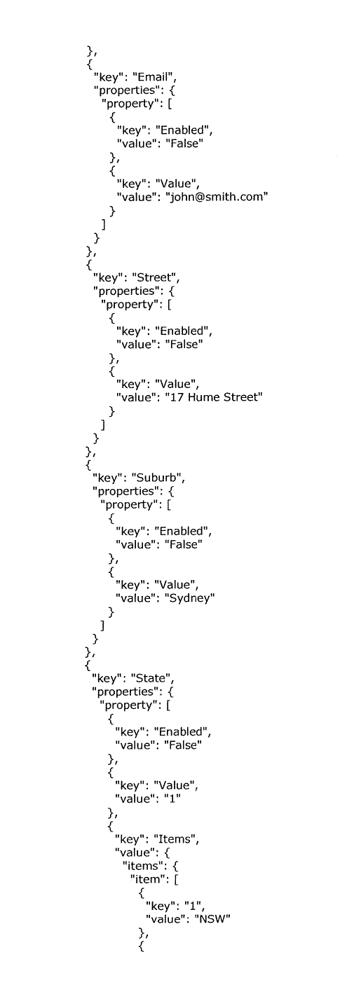

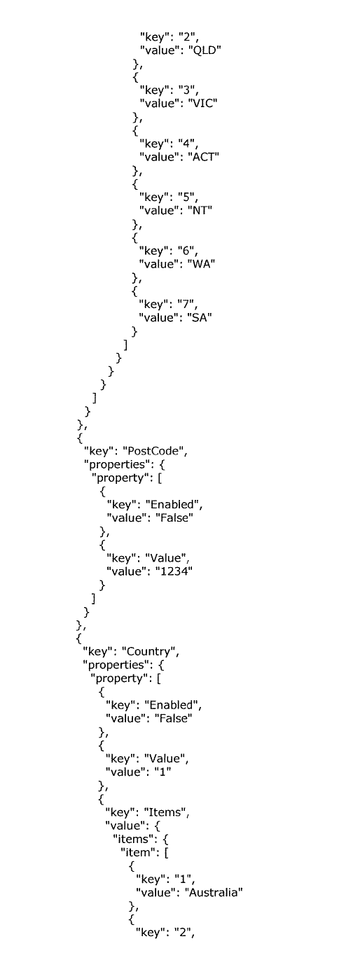

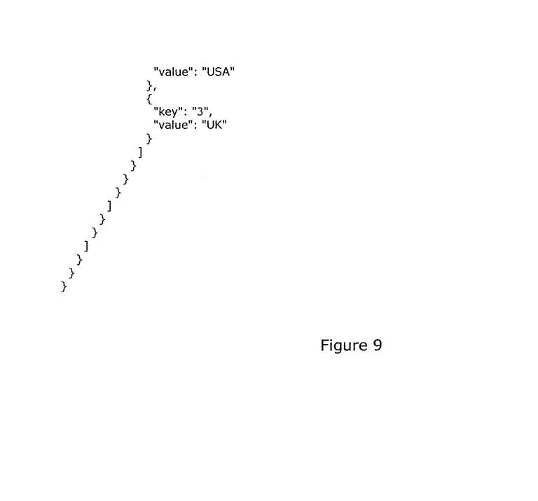

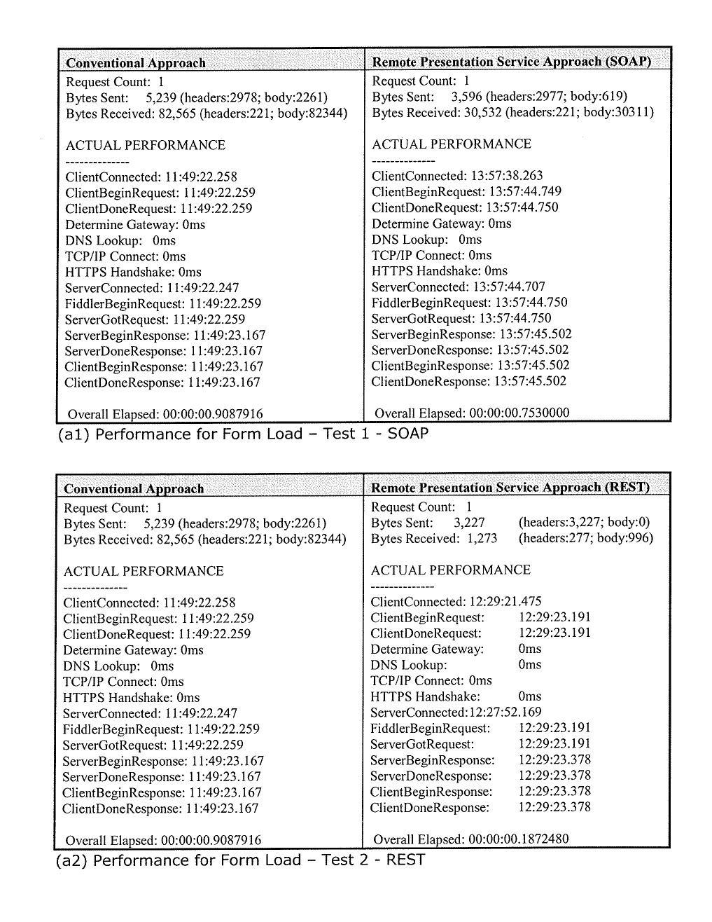

An example of a response that may be generated in Example 2, above is shown in FIGS. 8 and 9. This example is in both XML (FIG. 8) and JSON (FIG. 9), but other programming approaches or different markup languages may also be used.

### Example 4

### Performance Testing

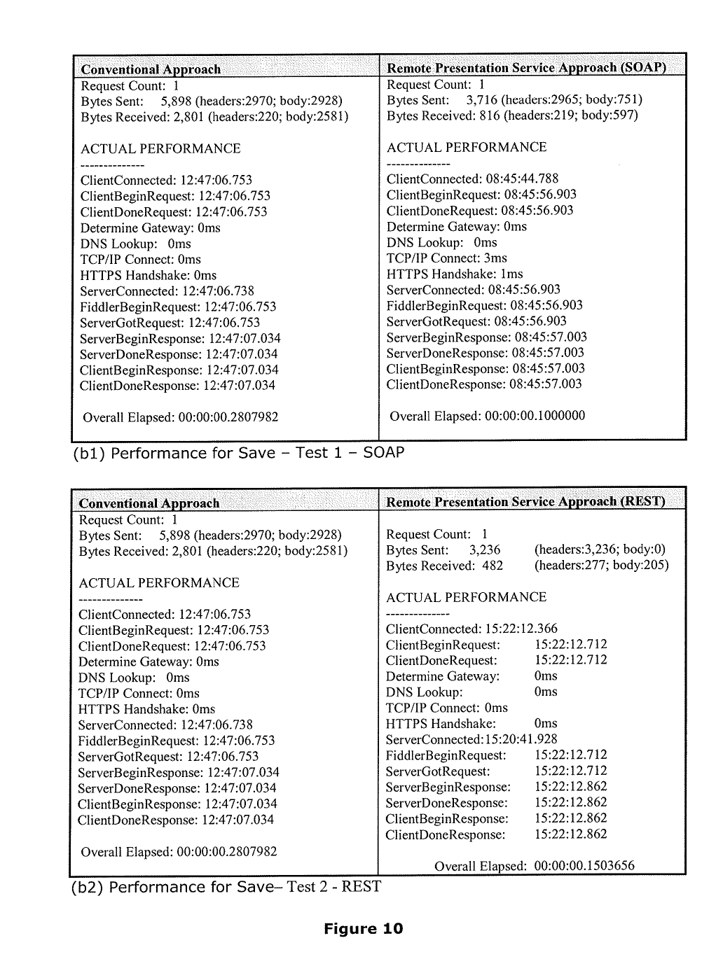

The performance comparing the conventional approach as exemplified in Example 1 with the present invention as proposed in Example 2 was determined. Some comparative results were obtained using the Fiddler 2 application. (Fiddler Web Debugger Version 2.3.5.2, Author Eric Lawrence), and are shown in FIG. 10.

A test of the performance for a ‘Form load’ operation was conducted, and the results are given in FIG. 10 part (a). The convention approach had an overall elapsed time of 0.9087916 seconds. In a first test conducted according to the invention, using the SOAP protocol and XML, the same operation took less time, namely 0.7530000 s, namely 82% of the time for the conventional approach. In a second test, using the REST protocol and JSON, the operation took 0.1872480 s, only 20% of the time for the conventional approach.

A test of the performance for a ‘Save’ operation was conducted, and the results are given in FIG. 10 part (a). The convention approach had an overall elapsed time of 0.2807982 seconds. In a first test conducted according to the invention, using the SOAP protocol and XML, the same operation took less time, namely 0.1000000 s, only 35% of the time for the conventional approach. In a second test, using the REST protocol and JSON, the operation took 0.1503656 s, only 53% of the time for the conventional approach.

The second test used different conditions to the conventional example and the first test, in that a virtualised server was used rather than a dedicated one, the workflow was more complex in the second test environment, because additional security and validation rules were implemented, and also there was an additional level of abstraction when mapping database fields, in that the same column in a table could be called multiple times, for example. The more complex environment in the second test explains why the time taken in the ‘save’ routine in the second test is more than in the first test, although the reverse occurred in the ‘form load’ test.

In this specification, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on. It will be apparent that obvious variations or modifications may be made which are in accordance with the spirit of the invention and which are intended to be part of the invention, and any such obvious variations or modifications are therefore within its scope.

### INDUSTRIAL APPLICABILITY

The invention can be utilised in the software development industry, in order to improve the efficiency of client/server software applications that interact over a communications network.

1. A client-server network of electronic devices that contains:
at least one server device having at least one database, and at least one server application that is adapted to process data in said database according to some business rules, and
at least one client device having at least one client application that is adapted to receive data input from a user and transmit this to the server application over the network and to display to the user data input by the user or received from the server application over the network, and the client application being adapted to process data according to some business rules, whereby
the client application and the server application exchange data over the network at least in part asynchronously, and the client application and the server application are synchronised with each other during the asynchronous data exchange.

2. The client-server network of claim 1, wherein the major portion of the business rules for processing data is located on the server application.

3. The client-server network of claim 2, wherein at least 80% of the business rules for processing data are located on the server application and less than 20% are located on the client application.

4. The client-server network of claim 3, wherein at least 90% of the business rules for processing data are located on the server application and less than 10% are located on the client application.

5. The client-server network of claim 4, wherein at least 95% of the business rules for processing data are located on the server application and less than 5% are located on the client application.

6. The client-server network of claim 5, wherein substantially all of the business rules for processing data are located on the server application.

7. The client-server network of claim 1, wherein substantially only the portion of the data output that is required to be displayed on the client device by the client application is transmitted from the server application.

8. The client-server network of claim 7, wherein when substantially only the portion of the data output that is required to be displayed on the client device by the client application is transmitted from the server application, then only the further portion of data that does not match any default values for the data to be displayed to the user is transmitted.

9. The client-server network of claim 1, wherein when a user inputs data using the client application then substantially only the portion of the data output that is changed is transmitted from the client application to the server application.

10. The client-server network of claim 1, wherein when a user undertakes an action using the client application, then substantially only the event arising from that action is transmitted from the client application to the server application.

11. The client-server network of claim 1, wherein when the server application processes data in the database according to some business rules, then substantially only the portion of the data that is changed is transmitted from the server application to the client application.

12. The client-server network of claim 11, wherein when the server application processes data in the database according to some business rules and substantially only the portion of the data that is changed is transmitted from the server application to the client application, then substantially only the further portion of the data output that is required to be displayed on the client device by the client application is transmitted from the server application.

13. The client-server network of claim 1, wherein the server application processes data substantially in a stateful manner.

14. The client-server network of claim 1, wherein the client application utilises a graphical user interface to receive data input by the user and to display data to the user.

15. The client-server network of claim 14, wherein the client application and the server application are synchronised by initially sending an asynchronous message from the client application, and responding by sending an asynchronous message from the server application, for each graphical user interface event that occurs.

16. The client-server network of claim 14, wherein the client application and the server application are synchronised by initially broadcasting an asynchronous message from the server application to the client application when a change is made by the server application.

17. The client-server network of claim 15 or claim 16, wherein substantially only data that has a direct impact on the graphical user interface is transmitted as part the message.

18. The client-server network of claim 1 wherein the data that is transmitted is compressed before transmission, and un-compressed upon receipt.

19. A computer implemented method for implementing asynchronous client-server transactions, in a client-server network of electronic devices that includes at least one server device having at least one database and at least one server application that is adapted to process data in the database according to some business rules, and at least one client device having at least one client application adapted to receive data input from a user and transmit this to the server application over the network and to display to the user data input by the user or received from the server application over the network, and the client application being adapted to process data according to some business rules,
the method comprising the step of:
the server application and the client application being synchronised at least while exchanging data over the network asynchronously.

20. The method of claim 19, wherein the major portion of the business rules for processing data is located on the server application.

21. The method of claim 19, wherein the client application utilises a graphical user interface to receive data input by the user and to display data to the user.

22. The method of claim 21, wherein the client application and the server application are synchronised by initially sending an asynchronous message from the client application, and responding by sending an asynchronous message from the server application, for each graphical user interface event that occurs.

23. The method of claim 21, wherein the client application and the server application are synchronised by initially broadcasting an asynchronous message from the server application to the client application when a change is made by the server application.

24. The method of claim 22, wherein substantially only data that has a direct impact on the graphical user interface is transmitted as part the message.
